(19) United States
(12) Patent Application Publication
(10) Pub. No.: US 2016/0334064 A1
(43) Pub. Date: Nov. 17, 2016

(54) LED Illuminating Device

(71) Applicant: ATW Technology Inc., New Taipei City (TW)

(72) Inventor: Hsien-Lu Lin, New Taipei City (TW)

(21) Appl. No.: 14/797,359

(22) Filed: Jul. 13, 2015

(30) Foreign Application Priority Data
May 15, 2015 (TW) 104207458

(51) Int. Cl. F21K 99/00; F21V 23/00

(52) U.S. Cl. CPC F21K 9/175; F21V 23/008; F21Y 2101/02; F21Y 2103/003

(57) ABSTRACT

A LED illuminating device includes a plurality of LED tubes, electrically connected in series and/or in parallel, and one LED tube driver, separately disposed outside the LED tubes and spaced apart from the LED tubes. The LED tube driver is electrically connected to the plurality of LED tubes through an external extension line. The LED tube driver and each LED tubes can be replaced individually so as to reduce the replacement cost. In addition, the LED tube driver is spaced apart from the LED tube, that the LED tube driver can avoid being damaged because of the heat. The lifetime of the LED tube driver is prolonged and the replacement frequency of the LED tube driver is reduced. Therefore, the LED illuminating device of the present invention has low maintenance cost.

### CROSS-REFERENCE TO RELATED APPLICATION

This application claims priority to Taiwan Patent Application No. 104207458 filed May 15, 2015, the disclosure of which is hereby incorporated in its entirety by reference.

### FIELD OF THE INVENTION

The present invention relates to a LED illuminating device, and more particularly to a LED illuminating device with low maintenance cost.

### BACKGROUND OF THE INVENTION

Conventional LED illuminating device comprises a LED tube and a build-in LED tube driver which is disposed inside the LED tube and is for driving the LED tube for illumination. When the LED beads of the LED tube or the build-in LED driver which is disposed inside the LED tube is out of function, a user has to replace the entire LED illuminating device comprising the LED tube and the LED tube driver. Furthermore, since the build-in LED driver is disposed inside the LED tube, in addition to the above drawback, it is also inefficient in heat dissipation to cause high-temperature heat emitted from the LED beads being prone to damage the build-in LED driver. Accordingly it causes frequent replacement of the conventional LED illuminating device, thereby increasing maintenance cost of the LED tube. Therefore, it is necessary to provide a LED illuminating device with low maintenance cost.

### SUMMARY OF THE INVENTION

Accordingly, an object of the present invention is to provide a LED illuminating device which has low maintenance cost.

To solve the issues in the prior art, the present invention provides a LED illuminating device, comprising: a plurality of LED tubes, electrically connected in series and/or in parallel, and one LED tube driver, separately disposed outside the LED tubes and spaced apart from the LED tubes, wherein the LED tube driver is electrically connected to the plurality of LED tubes through an external extension line so as to drive the plurality of LED tubes, and the external extension line is disposed outside both the LED tubes and the LED tube driver.

According to an embodiment of the present invention, the LED illuminating device further comprises a light panel that accommodates the plurality of LED tubes, wherein the LED tube driver is detachably disposed on the light panel.

According to an embodiment of the present invention, the LED tube driver and the plurality of LED tubes are disposed at a light-facing side of the light panel.

According to an embodiment of the present invention, the plurality of LED tubes is disposed at a light-facing side of the light panel, and the LED tube driver is disposed at a non-light-facing side of the light panel.

According to an embodiment of the present invention, the light panel includes an opening that passes through the light-facing side and the non-light-facing side.

According to an embodiment of the present invention, the LED tube driver is a DC driver.

According to an embodiment of the present invention, the LED illuminating device further comprises a light reflector that is disposed between the LED tubes and the light panel.

By the technical means adopted by the present invention, the LED tube driver and each LED tubes can be demounted and replaced individually instead of being replaced together so as to reduce the replacement cost. In addition, since the LED tube driver is allocated to space apart from the LED tube that emits high-temperature heat, the LED tube driver can be protected from being damaged by high temperature. Thus, the lifetime of the LED tube driver is prolonged and the replacement frequency of the LED tube driver is reduced. Therefore, the LED illuminating device of the present invention has low maintenance cost.

Furthermore, the LED illuminating device of the present invention utilizes one LED tube driver to drive the plurality of LED tubes, so it becomes unnecessary to manufacture the same amount of LED tube drivers and the LED tubes to thus reduce the manufacturing cost of the LED tube drivers.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram illustrating a LED illuminating device according to a first embodiment of the present invention;

FIG. 2 is a schematic diagram of the LED illuminating device according to a second embodiment of the present invention;

FIG. 3 is schematic diagram of the LED illuminating device according to a third embodiment of the present invention;

FIG. 4 is a side view of the LED illuminating device according to the first embodiment of the present invention; and

FIG. 5 is a side view of the LED illuminating device according to the second embodiment of the present invention.

### DETAILED DESCRIPTION OF THE PREFERRED EMBODIMENTS

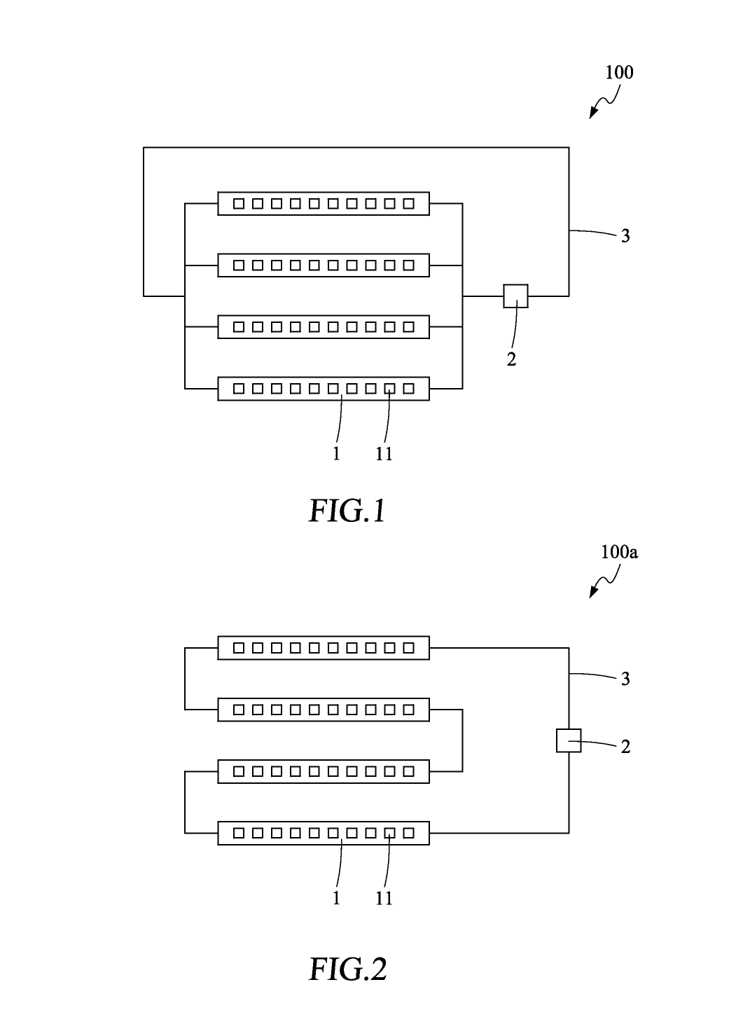

The preferred embodiments of the present invention are described in detail below with reference to the FIG. 1 to FIG. 5. The description is used for explaining the embodiments of the present invention only, but not for limiting the scope of the claims.

As shown in FIG. 1, a LED illuminating device 100 according to an embodiment of the present invention includes: a plurality of LED tubes 1 which are electrically connected in series and/or in parallel; and one LED tube driver 2 separately disposed outside the LED tubes 1 and spaced apart from the LED tubes 1, wherein the LED tube driver 2 is electrically connected to the plurality of LED tubes 1 through an external extension line 3 so as to drive the plurality of LED tubes 1, and the external extension line 3 is disposed outside both the LED tubes 1 and the LED tube driver 2.

Each LED tubes 1 includes a plurality of LED beads 11 as the illuminating sources. The LED tube driver 2 is a DC driver, which outputs a constant direct current so as to drive the LED tubes 1. The input current source of the LED tube driver 2 can be direct current or alternate current.

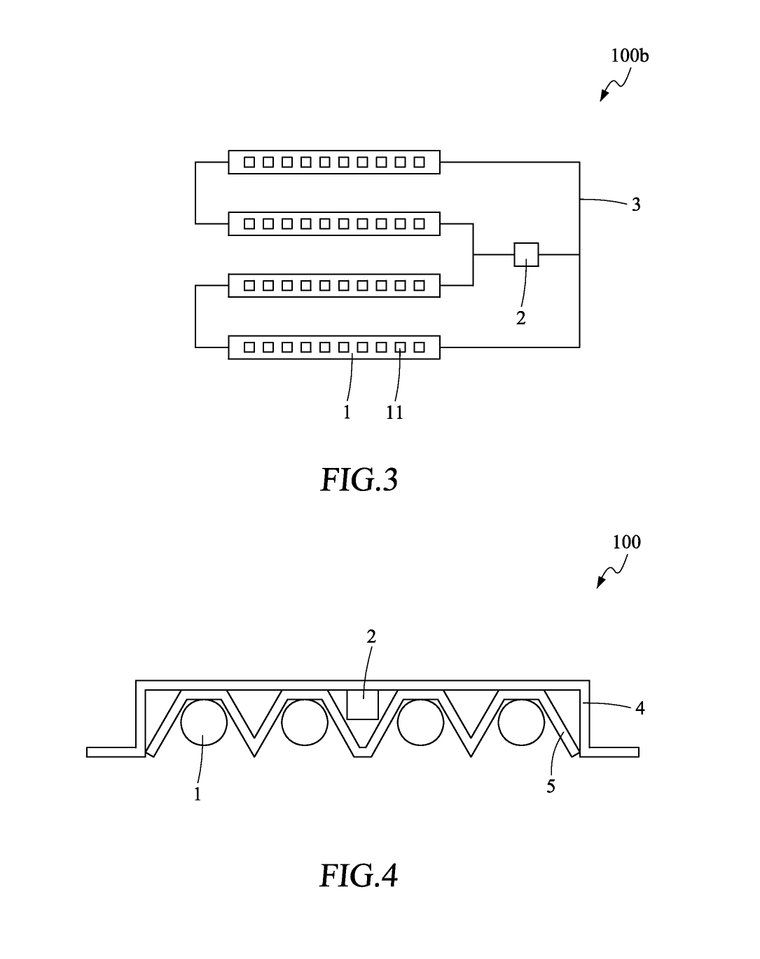

In the LED illuminating device 100 according to the first embodiment of the present invention as shown in FIG. 1, four side-by-side LED tubes 1 are electrically connected in parallel. In the LED illuminating device 100a according to the second embodiment of the present invention as shown in FIG. 2, four side-by-side LED tubes 1 are electrically connected in series. In the LED illuminating device 100b according to the third embodiment of the present invention as shown in FIG. 3, there are four side-by-side LED tubes 1 grouped in twos, in which each group forms a light set. The LED tubes 1 which belong to two different light sets are electrically connected in parallel. The two LED tubes 1 in each light set are electrically connected in series.

In the LED illuminating device 100 according to the first embodiment of the present invention as shown in FIG. 4, the LED illuminating device 100 further includes a light panel 4 for being fastened on ceilings or walls. The light panel 4 accommodates the plurality of LED tubes 1, and the LED tube driver 2 is detachably disposed on the light panel 4. In the present embodiment, the LED tube driver 2 and the plurality of LED tubes 1 are disposed at a light-facing side of the light panel 4, wherein the LED tube driver 2 is spaced apart from the LED tubes 1, which can reduce the impact of the high-temperature heat emitted from the LED tubes 2 on the LED tube driver 1 so as to prolong the lifetime of the LED tube driver 2.

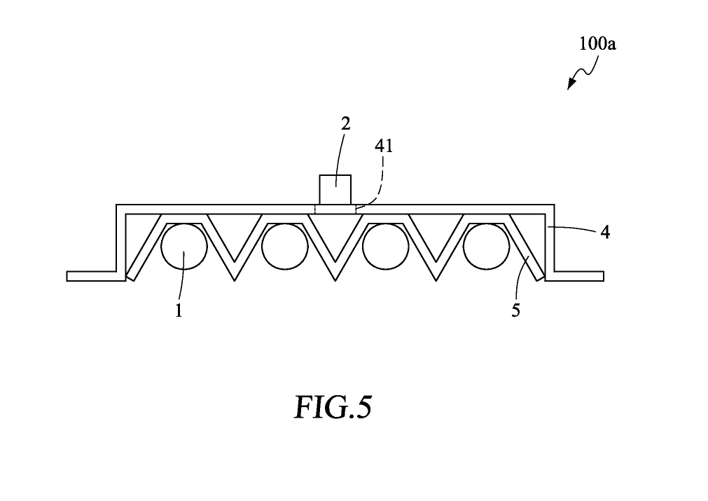

In the LED illuminating device 100a according to the second embodiment of the present invention as shown in FIG. 5, the plurality of LED tubes 1 are disposed at a light-facing side of the light panel 4, and the LED tube driver 2 is disposed at a non-light-facing side of the light panel 4. The LED tube driver 2 is spaced apart from the LED tubes 1. In addition, by the light panel 4 which acts as a blocker blocking the high-temperature heat from the LED tubes 1, the high-temperature heat from the LED tubes 1 can be further reduced so as to prolong the lifetime of the LED tube driver 2.

In the LED illuminating device 100a according to the second embodiment of the present invention as shown in FIG. 5, the light panel 4 has an opening 41 that passes through the light-facing side and the non-light-facing side. The LED tube driver 2 at the non-light-facing side of the light panel can be taken out via the opening 41 so as to improve the convenience of demounting the LED tube driver 2.

In the LED illuminating device 100, 100a according to the embodiment of the present invention as shown in FIG. 4 and FIG. 5, the LED illuminating device 100, 100a further includes a light reflector 5 that is disposed between the LED tubes 1 and the light panel 4. The light reflector 5 reflects the light emitted from the LED tubes 1 to confine the directions of the light so as to raise the illumination efficiency.

By the structures mentioned above, the LED tube driver 2 and all LED tubes 1 of the present invention can be demounted and replaced individually so as to reduce the replacement cost. In addition, since the plurality of LED tubes 1 is driven by one LED tube driver 2, it has a merit that it is unnecessary to manufacture the LED tube driver 2 and the LED tubes 1 with the same amount, and thus the manufacturing cost is reduced. Furthermore, the LED tube driver 2 is spaced apart from the LED tube 1 that emits high-temperature heat, which can protect the LED tube driver 2 from being damaged by high temperature. Thus, the lifetime of the LED tube driver 2 is prolonged and the replacement frequency of the LED tube driver 2 is reduced. Therefore, the maintenance cost of the LED illuminating device of the present invention is reduced.

The above description should be considered as only the discussion of the preferred embodiments of the present invention. A person having an ordinary skill in the art may make various modifications to the present invention. However, those modifications still fall within the spirit of the present invention and scope defined by the appended claims.

What is claimed is:

1. A LED illuminating device, comprising:
a plurality of LED tubes, electrically connected in series and/or in parallel; and
one LED tube driver, separately disposed outside the LED tubes and spaced apart from the LED tubes, wherein the LED tube driver is electrically connected to the plurality of LED tubes through an external extension line so as to drive the plurality of LED tubes, and wherein the external extension line is disposed outside both the LED tubes and the LED tube driver.

2. The LED illuminating device as claimed in claim 1, further comprising a light panel that accommodates the plurality of LED tubes, wherein the LED tube driver is detachably disposed on the light panel.

3. The LED illuminating device as claimed in claim 2, wherein the LED tube driver and the plurality of LED tubes are disposed at a light-facing side of the light panel.

4. The LED illuminating device as claimed in claim 2, wherein the plurality of LED tubes are disposed at a light-facing side of the light panel, and wherein the LED tube driver is disposed at a non-light-facing side of the light panel.

5. The LED illuminating device as claimed in claim 4, wherein the light panel includes an opening that passes through the light-facing side and the non-light-facing side.

6. The LED illuminating device as claimed in claim 1, wherein the LED tube driver is a DC driver.

7. The LED illuminating device as claimed in claim 2, further comprising a light reflector that is disposed between the LED tubes and the light panel.
